(19) United States
(12) Patent Application Publication
(10) Pub. No.: US 2024/0262279 A1
(43) Pub. Date: Aug. 8, 2024

(54) STRAP WINDING SYSTEMS

(71) Applicant: USINAGE NUMERIQUE H.B. INC., Dolbeau-Mistassini (CA)

(72) Inventors: Hermel BUJOLD, Dolbeau-Mistassini (CA); Pierre THERIAULT, Dolbeau-Mistassini (CA); Vincent GIRARD, Dolbeau-Mistassini (CA)

(21) Appl. No.: 18/428,111

(22) Filed: Jan. 31, 2024

Related U.S. Application Data
(60) Provisional application No. 63/482,825, filed on Feb. 2, 2023.

(51) Int. Cl. B60P 7/08

(52) U.S. Cl. CPC B60P 7/0853; B60P 7/0846

(57) ABSTRACT

Straps used on flatbeds can be unwound from a winch drum by using a system that includes a winding assembly, a bracket that enables the assembly to be supported on the flatbed, and a needle that can be removably mounted to a rotating element of the assembly. The strap can be connected to the needle and then rotation enables the strap to be unwound from the drum and would up onto the needle. The wound-up strap can then be removed and stored when not in use.

### CROSS-REFERENCE TO RELATED PATENT APPLICATIONS

This application claims the benefit of U.S. Provisional Application No. 63/482,825 filed on 2 Feb. 2023, the contents of which are hereby incorporated by reference in their entirety.

### TECHNICAL FIELD

The technical field generally relates to winding straps such as those present on flatbed winches, e.g., methods and systems for use with a flatbed winch for winding tie-down straps or other winding or rotation applications.

### BACKGROUND

Cargo tie-downs, also called hold downs or lashing straps, are commonly used to secure loads on open top compartments, such as truck trailers. The strap, band or cord is tensioned across the load to secure the load to the vehicle.

Typically, a flatbed winch is used to wind the straps tightly around the load. The use of multiple flatbed winches and straps can be desirable for securing large loads. When using a typical flatbed winch, the winding of the winch becomes increasingly difficult as the straps are being tightened. A rod can often be used to act as a lever that connects to part of the winch such that a user can forcibly push downward on the rod to tighten the straps.

However, using a rod to manually wind the winch has various disadvantages, such as increased risk of injury and inefficiency. In addition, there can be a desire to remove the straps from the flatbed when the straps are not in use for storage.

There is a need for methods and systems that overcome at least some of the disadvantages of what is known in the art.

### SUMMARY

Straps used on flatbeds can be unwound from a winch drum by using a system that includes a winding assembly, a bracket that enables the assembly to be supported on the flatbed, and a needle that can be removably mounted to a rotating element of the assembly. The strap end can be connected to the needle and then rotation enables the strap to be unwound from the drum and would up onto the needle. The wound-up strap can then be removed and stored when not in use. The needle, bracket and assembly can have various features and embodiments, some of which are described below. It is also noted that the system can include the bracket and assembly for winch winding applications where the needle is not used, and can include the needle and assembly for removal of straps when the user supports the drill and system manually rather than being supported via the bracket. In addition, each of the bracket, the assembly and the needle include visual distinctive features regarding shape and configuration.

### BRIEF DESCRIPTION OF THE DRAWINGS

The attached figures illustrate various features, aspects and implementations of the technology described herein.

FIG. 1 is a side schematic view of a flatbed winch commonly used for winding straps according to prior art.

FIG. 2 is a perspective view of a winch-winding assembly according to an embodiment of the present invention, attached to a hand-held drill.

FIG. 3A is a front perspective view of a winch-winding assembly.

FIG. 3B is a rear perspective view of the winch-winding assembly shown in FIG. 3A.

FIG. 4 is a front perspective partially-exploded view of a winch-winding assembly.

FIG. 5 is a cross-sectional view of part of a worm gear that is part of a winch-winding assembly.

FIG. 6 is a front cross-sectional view of a finger mounted on a stem that is part of a winch-winding assembly, showing the finger extending from a retracted position to an extended position.

FIG. 7 is a top perspective view of another embodiment of a winch-winding assembly.

FIG. 8 is a side plan partial transparent view of an embodiment of a winch-winding assembly.

FIG. 9 is a side plan view of a worm wheel and part of an engagement arm.

FIG. 10 is a front plan view of FIG. 9.

FIG. 11 is a perspective view of a worm wheel that can be part of a winch-winding assembly.

FIG. 12 is a side plan partial transparent view of part of an engagement arm that can be part of a winch-winding assembly.

FIG. 13 is a front plan view of FIG. 12.

FIG. 14 is a perspective view of a finger that can be part of a winch-winding assembly.

FIG. 15 is a worm that can be part of a winch-winding assembly.

FIG. 16 is a side plan view of a cap element that can be part of a winch-winding assembly.

FIG. 17 is a perspective view of bottom part of a collar that can be part of a winch-winding assembly.

FIG. 18 is a perspective view of a top part of a collar that can be part of a winch-winding assembly.

FIG. 19 is a perspective view of a bottom part of a collar that can be part of a winch-winding assembly.

FIG. 20 is a side plan partial transparent view of a top part of a collar that can be part of a winch-winding assembly.

FIG. 21 is a top plan partial transparent view of part of a support arm that can be part of a winch-winding assembly.

FIG. 22 is a perspective view of part of a gear box that can be part of a winch-winding assembly.

FIG. 23 is a side plan partial transparent view of part of a gear box that can be part of a winch-winding assembly.

FIG. 24 is a side front partial transparent view of part of a gear box that can be part of a winch-winding assembly.

FIG. 25 is a perspective view of another part of a gear box that can be part of a winch-winding assembly.

FIG. 26 is a side plan partial transparent view of another part of a gear box that can be part of a winch-winding assembly.

FIG. 27 is a side front partial transparent view of another part of a gear box that can be part of a winch-winding assembly.

FIG. 28 is a perspective view schematic of part of another embodiment of a winch-winding assembly.

FIGS. 29A to 29D are plan view schematics that illustrate the movement of a finger during rotation of a stem, which may be used in a winch-winding assembly.

FIG. 30 is a plan view schematic of a winding assembly, an adaptor and a windable device.

FIG. 31 is a perspective view of a winding assembly.

FIG. 32 is a side plan view of a winding assembly.

FIG. 33 is a top plan view of a winding assembly.

FIGS. 34 and 35 are perspective views of a winding assembly.

FIGS. 36 to 48 include schematics and photographs of various components that can be used in a system for winding straps.

### DETAILED DESCRIPTION

Techniques described herein relate to systems and methods for winding straps, such as tie-down straps used in flatbeds. The winding system can include a winding assembly, embodiments of which will be described in details below; a mounting bracket that can be mounted to the flatbed and coupled to the winding assembly to support the same; and a winding needle that can be connected to a rotating element of the winding assembly and to the strap to wind the strap around the needle. After the strap is wound around the needle, the wound-up strap can be removed from the needle for storage when not in use. When the strap is to be re-installed, it can be place back on the needle and then wound back onto the winch of the flatbed. It is also noted that the needle can be removably mounted to the rotating element of the winding assembly, and the winding assembly can be configured to wind straps without use of the needle, as described in various embodiments below.

The needle can be viewed as an adapter that can be coupled to the winding assembly for facilitating additional functionality. The bracket can be viewed as a component that can enable mounting of the winding assembly for positioning and/or so that the user does not have to hold up the drill and assembly manually. More regarding the overall system will be described further below. First, embodiments of the winding assembly will be described.

The winch-winding assembly can be connectable to a flatbed winch for winding tie-down straps. Advantageously, the winch-winding assembly has a rotatable element that can be coupled to part of the flatbed winch without structurally modifying the flatbed winch. In some implementations, the winch-winding assembly includes an engagement arm that is configured to facilitate coupling to the winch and/or includes a drill-support mechanism configured to facilitate guiding or supporting a drill or a hand-held drill used to drive the winch-winding assembly.

The term “hand-held drill” can include any portable powered device adaptable for causing a rotation of the winch-winding assembly. It is noted that the hand-held drill can be completely supported by a user in operation or can be mounted to the bracket for support while the user operates the drill for winding.

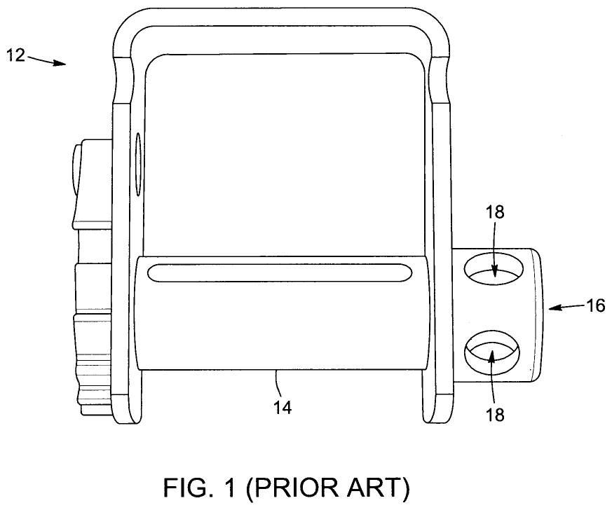

Referring to FIG. 1, there is shown a typical flatbed winch 12. The flatbed winch 12 includes a winch drum 14 having an open end 16 and at least a lateral opening 18. The flatbed winch 12 is a mechanical device used to wind up a rope, a strap or the like. It should be noted that the winch-winding assembly can be used for winding the flatbed winch 12 or various other types of winches or similar windable mechanisms.

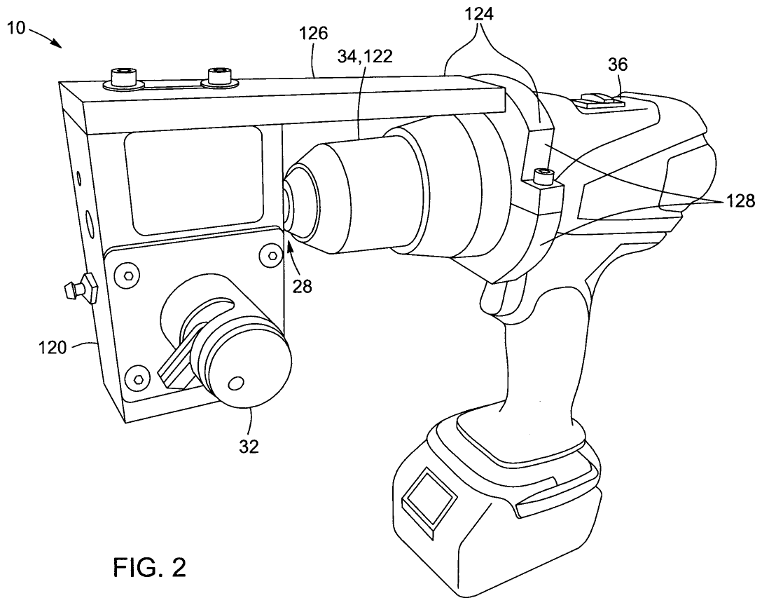

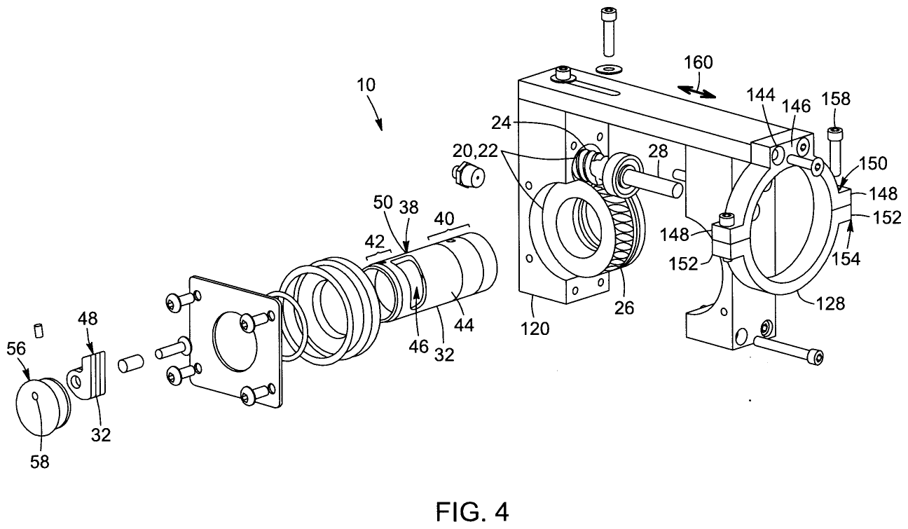

With reference to FIGS. 2 and 4, there is shown an embodiment of a winch-winding assembly 10 attached to a hand-held drill 36. The winch-winding assembly 10 includes a gear system 20. The gear system 20 can include gear arrangements that can reduce an input rotational velocity into a suitable output rotational velocity.

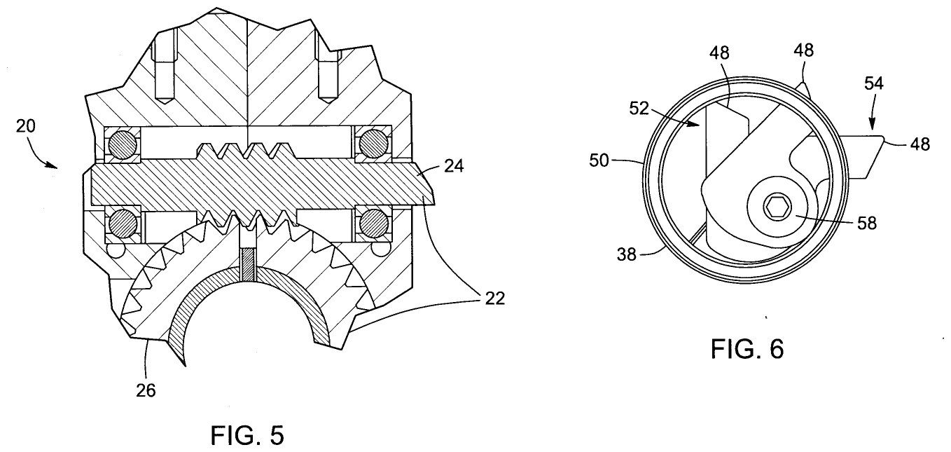

In the illustrated embodiment of FIGS. 4 and 5, the gear system 20 comprises a worm gear set 22. The worm gear set 22 includes a worm 24 and a worm wheel 26. The worm 24 can be a gear in the form of a screw that meshes with the worm wheel 26. The worm wheel 26 can be a gear similar to a spur gear.

The worm gear set 22 can be configured to produce a velocity ratio, defined as the input rotational velocity of the hand-held drill 36 over the output rotational velocity, between 1 and 50, between 2 and 30, or between 5 and 20 for example. Preferably the velocity ratio is 10.

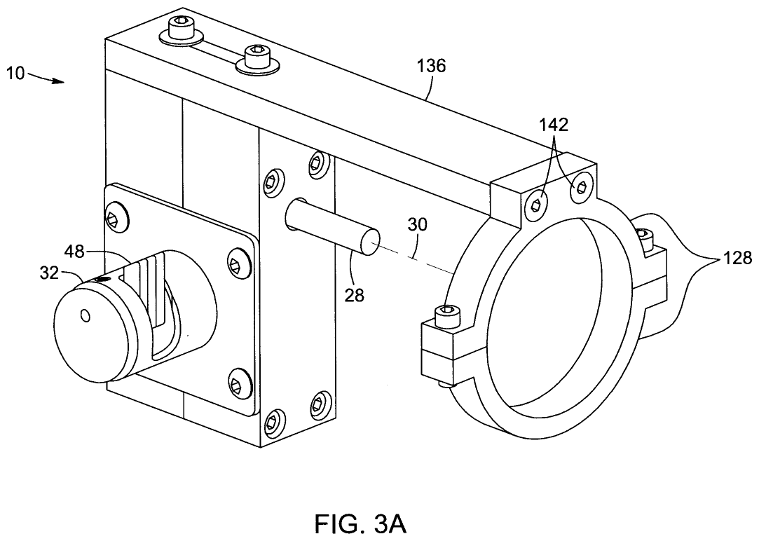

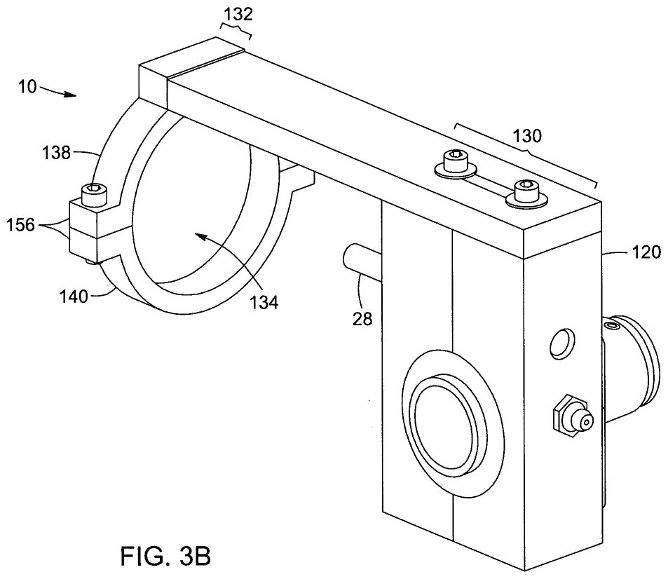

Referring to FIGS. 3A and 4, the winch-winding assembly 10 also includes a drive shaft 28 connected to the gear system 20 and being rotatable about a longitudinal axis 30 thereof in order to cause rotation of the gear system 20. The drive shaft 28 is configured to be engaged by the hand-held drill 36 to effect the rotation thereof. The drive shaft 28 can be any element suitable for connecting the gear system 20 to the hand-held drill 36. For example, the drive shaft 28 can refer to a generally cylindrical elongated structure. The drive shaft 28 may also be hollow.

In the illustrated embodiment shown in FIG. 4, the worm 24 is integrally connected to the drive shaft 28. In other embodiments, the drive shaft 28 can be removable from the worm 24 for selecting a corresponding drive shaft 28 according to the type of the hand-held drill 36 to be used. In some embodiments, the drive shaft 28 maybe a tool such as a drive bit and/or a tool bit. The drive bit and/or tool bit may be any rotary bits suitable for use with the hand-held drill 36 and engageable with the worm 24.

In operation, the hand-held drill 36 can be activated to rotate a drill chuck 34 thereof and consequently rotate the drive shaft 28.

In some embodiments, the winch-winding assembly 10 also includes an engagement arm 32 configured to engage with and rotate the winch drum 14. The engagement arm 32 can be a cylindrical elongated structure capable of transmitting a rotational movement between two rotary parts.

With reference to FIG. 4, the engagement arm 12 includes a stem 38 rotatable about a longitudinal axis thereof. The stem 38 can be viewed as the supporting body or the elongated structure of the engagement arm 32. The stem 38 can include a tubular wall 44 defining a channel 50 and having a lateral aperture 46.

In addition, the stem 38 includes a proximal portion 40 attached to the gear system 20 to be rotated thereby, and a distal portion 42 extending away from the gear system 20. For example, the worm wheel 26 can be connected to the proximal portion 40 of the stem 38. The connection can be achieved using a fastener, press-fitting the stem 38 into an opening in the worm wheel 26 or any other suitable means.

The drive shaft 28 can be configured to be perpendicular with respect to the stem 38 of the engagement arm 32. This configuration may be more efficient when using a worm gear set 22 since the axis of rotation of the worm 24 is generally perpendicular to the axis of rotation of the worm wheel 26.

Referring to FIGS. 3A, 4 and 6, the engagement arm 32 also includes a finger 48 mounted to the distal portion 42 of the stem 38 and being displaceable, as shown in FIG. 6, between a retracted position 52 and an extended position 54. The finger 48 can be a connector having a shape and construction as a plate, a rod, a tube, a bar or the like. The finger 48 can include a sloped tip for allowing sufficient clearance between the sloped tip and the structure defining the lateral aperture 46 while displacing between the retracted position 52 and the extended position 54. In the illustrated embodiment, the finger 48 is mounted within the channel 50 of the stem 38.

FIG. 6 illustrates a finger 48 extending from the retracted position 52 to the extended position 54. In the retracted position 52, the finger 48 is retracted sufficiently to allow the distal portion 42 to be axially insertable into the open end 16 of the winch drum 14 (e.g., as shown in FIG. 1). In the extended position 54, the finger 48 extends through the lateral opening 18 of the winch drum 14 in order to engage and rotate the winch drum 14 in response to rotation of the stem 38.

In a preferred embodiment, the finger 48 can be mounted and configured so as to be fully housed within the channel 50 in the retracted position 52 and to partially extend through the lateral aperture 46 in the extended position 54. The partial extension of the finger 48 is preferably sufficient to securely engage the winch drum 14 through the lateral opening 18 and to prevent unintentional disengagement with the winch drum 14.

In the illustrated embodiment shown in FIG. 6, the finger 48 is pivotally mounted within the channel 50 to be pivotable between the retracted position 52 and the extended position 54.

In one embodiment, as shown in FIGS. 4 and 6, the finger 48 includes multiple coplanar finger elements. Each finger element is a plate that can independently pivot and is in contact with an adjacent finger element.

Referring back to FIG. 4, the engagement arm 32 can further include an end cap 56 fitted on an extremity of the distal portion 42, the end cap 56 comprising a hinge 58 extending within the channel 50 and to which the finger 48 is pivotally mounted. The end cap 56 can protect the finger 48, internal components of the stem, and the gear system 20 from foreign objects by sealing an end of the channel 50.

The hinge 58 can be any device connecting the finger 48 to the engagement arm 32 in order to pivot the finger 48 between the retracted position 52 and the extended position 54. In a preferred embodiment, the hinge 58 is offset with respect to the longitudinal axis of the stem 38. The offset distance can be provided depending on the length and configuration of the finger 48.

In operation, the finger 48 is mounted to the hinge 58 and configured to pivot to the extended position 54 in response to rotation of the stem 38 in a winch-tightening direction, and to pivot to the retracted position 52 in response to rotation of the stem 38 in a winch-loosening direction.

In accordance with another optional aspect, the winch-winding assembly is configured for supporting a hand-held drill.

Referring to FIGS. 2 and 4, the winch-winding assembly 10 includes a gear box 120 in which the gear system 20 is mounted. The gear box 120 can include various casing constructions adapted to contain, house or provide an outer fixed structure for the gear system 20.

Referring to FIGS. 2, 3A, 3B and 4, the winch-winding assembly 10 also includes a drill-support mechanism 124, for supporting the hand-held drill 36. The drill-support mechanism 124 comprises a support arm 126 and a collar 128.

In the illustrated embodiment, the support arm 126 has a proximal section 130 connected to the gear box 120 and a distal section 132 extending away from the gear box 120. The support arm 126 can be any rigid structure connecting the gear box 120 with the collar 128 and may be composed of one or multiple elements. The support arm 126 may also comprise a telescoping structure 160 for adjusting the distance of the collar 128 with respect to the gear box 120 and drive shaft 28. In the illustrated embodiment of FIG. 3A, the support arm 126 comprises a plate 136 fixed to and extending from an upper end of the gear box 120. In this embodiment, the plate 136 is spaced apart from and generally parallel with respect to the drive shaft 28. This configuration facilitates the use of a typical hand-held drill 36 as shown in FIG. 2.

In the illustrated embodiment, the collar 128 is connected to the distal section 132 of the support arm 126 and defines an insertion region 134 in which the hand-held drill 36 is guidable so as to engage the drive shaft 28. The collar 128 is spaced away from the drive shaft 28 and can be configured such that the collar 128 abuts on and supports a body of the hand-held drill 36 during engagement and rotation of the drive shaft 28. The term “collar” refers to a component or device comprising parts for at least partially confining, encircling or defining an opening for part of the body of the hand-held drill 36. In the illustrated embodiment of FIG. 3A, the collar 128 comprises a closed annular member defining a generally circular insertion region 134. In some embodiments, the collar is fixed in place and does not move as the drill is inserted or during winding operations. In other embodiments, the collar 128 can comprise a clamping mechanism, such as a C-clamp, for clamping and holding the body of the hand-held drill 36 after insertion and during operation. Preferably the collar 128 is made from rigid materials.

In the illustrated embodiment of FIGS. 3A and 3B, the collar 128 comprises an upper member 138 attached to an extremity of the distal section 132 of the support arm 126 and a lower member 140 attachable to the upper member 138. The upper and lower members can have different shapes. Ideally, the shape of the insertion region 134 corresponds to the shape of the body of the hand-held drill 36. In the illustrated embodiment, the upper member 138 and the lower member 140 are generally U-shaped. This configuration can be adapted to receive a typical hand-held drill 36.

Referring to FIG. 3A, the drill-support mechanism 124 comprises at least one fastener 142 for attaching the upper member 138 to the distal section 132 of the support arm 126. Accordingly, as shown in FIG. 4, the distal section 132 of the support arm 126 includes at least one opening 144 for receiving the at least one fastener 142. In one embodiment, the upper member 138 includes a protrusion 146 extending radially from the upper member 138 and adapted to receive the at least one fastener 142.

With reference to FIG. 4, there is shown an embodiment wherein the upper member 138 includes at each end thereof a lug 148 comprising an aperture 150. The lower member 140 also includes at each end thereof a corresponding lug 152 comprising an aperture 154. Still referring to FIG. 4 and with reference to FIG. 3B, the lugs 148 of the upper member 138 can abut with respective lugs 152 of the lower member 140 to align the corresponding apertures 150, 154 and form lug pairs 156 that are connectable together to attach the lower member 140 to the upper member 138. The lugs 148, 152 generally refer to any fastening element for attaching the lower member 140 to the upper member 138.

The collar 128 can further include a plurality of lug fasteners 158, each lug fastener 158 being insertable through the apertures 150, 154 of a corresponding lug pair 156 for securing the lug pair 156 together, thereby attaching the lower member 140 to the upper member 138.

In operation, the hand-held drill 36 is inserted into the insertion region 134 of the collar 128 and guided so as to engage the drive shaft 28. The hand-held drill 36 can then be activated in order to cause rotation of the gear system 20 and consequently rotation of the engagement arm 32 for winding the flatbed winch 12. Advantageously, in some embodiment the drill-support mechanism 124 is configured to substantially reduce and/or limit transmissible torque, produced during the winding process, on a handle of the hand-held drill 36 by confining and securing the hand-held drill 36 in place.

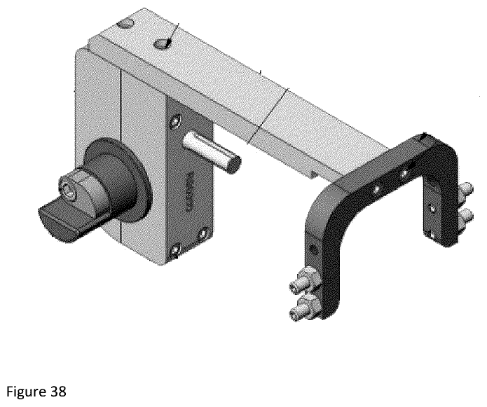

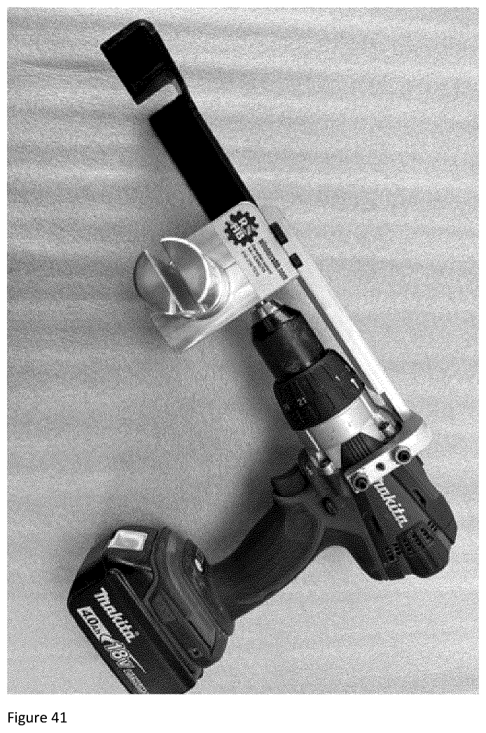

Referring to FIGS. 38, 39 and 41, the collar has an alternative configuration where it is open ended for insertion of the drill and can thus be viewed as including only the upper member. The collar can include nuts and bolts on either side for coupling the drill body where the bolts extend through corresponding apertures in the upper member and contact the drill body while the nuts retain the bolts in place. It is also noted the support arm can include features, such as openings, to connect to the bracket to support the weight of the drill and assembly during operation.

In some implementations, the gear system is configured so that, when used with a drill and high resistance to rotation is encountered, the drill will shut down or stutter before the gears are damaged.

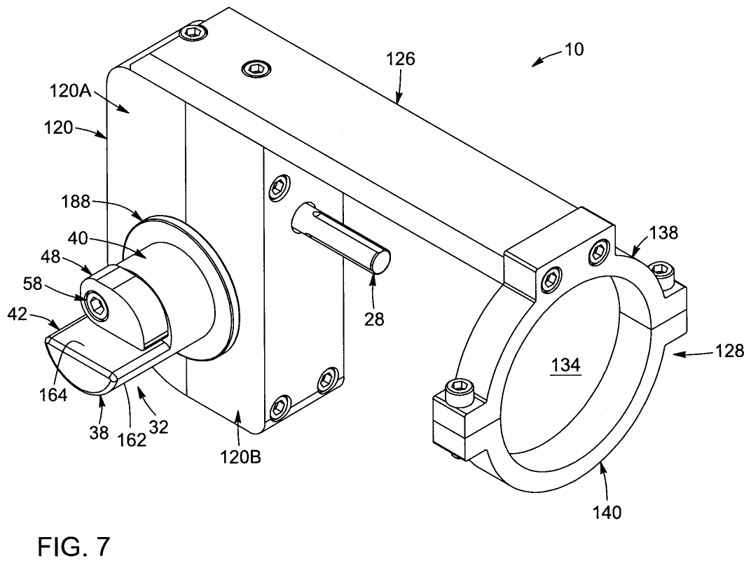

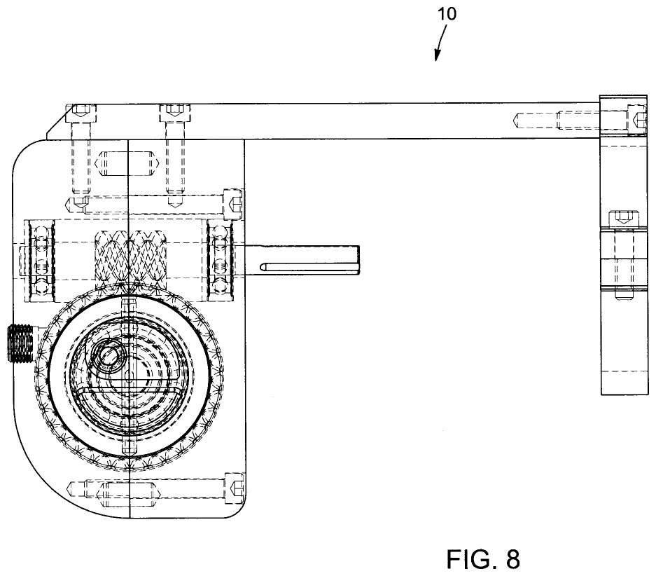

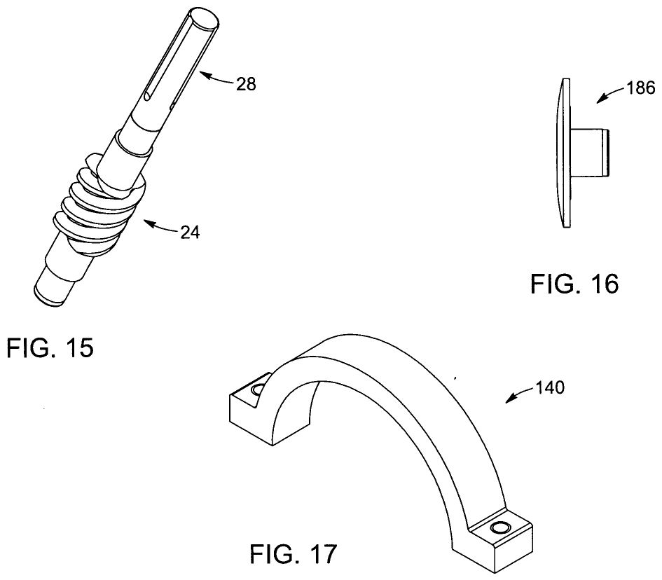

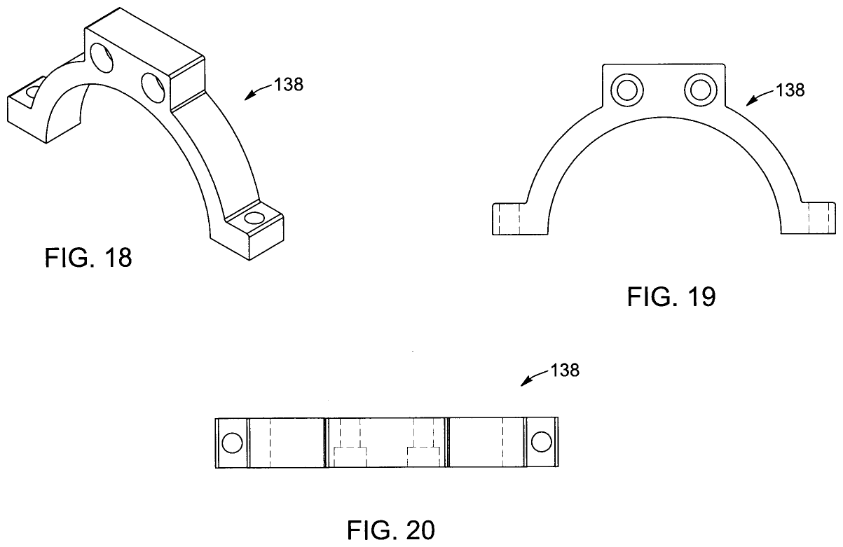

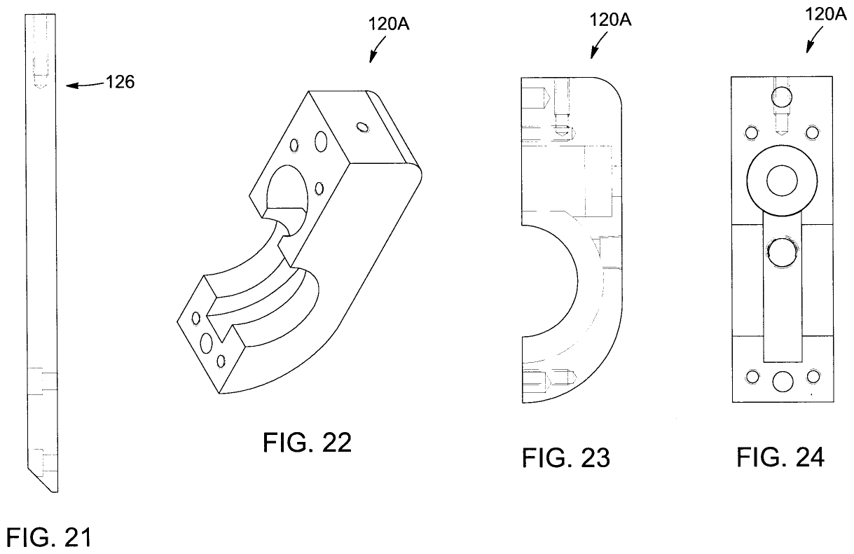

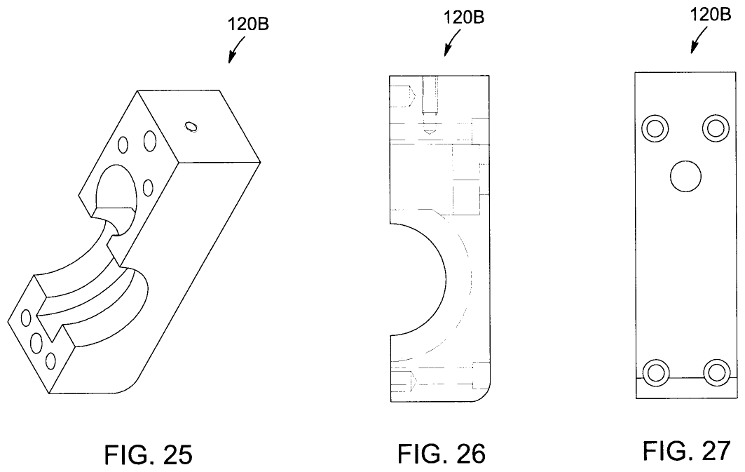

Referring now to FIGS. 7 to 27 and 29A to 29D, another embodiment of a winch-winding assembly and its components are illustrated. As shown in FIG. 7, the engagement are includes a stem 38 mounted to the worm gear to be rotated thereby, and a finger 48 mounted to the stem 38. The stem and finger construction and configuration in the embodiment of FIG. 7 are somewhat different from that of FIGS. 3A and 3B, for example.

Referring to FIG. 7, the stem 38 can include a proximal portion 40 mounted to the worm gear and a distal portion 42 for insertion into the winch drum. The stem 38 and/or either one of its proximal and distal portions 40, 42 can have a solid construction (e.g, composed of solid metal) or a hollow construction. When a hollow construction is used, the stem 38 is preferably enclosed to the outside environment to prevent particulate material or other such material from accumulating in the structure. The solid stem can be manufactured by machining a single solid metal piece to provide the desired shape and configuration. A solid construction provides advantages with respect to avoiding dirt or the like from entering in to the structure. It is also noted that the stem can be composed of a variety of materials, such as steel, aluminum or other metals or alloys; polymeric materials; composite materials; or various other materials. The material used for the stem can be designed to have certain mechanical and physical properties for the forces to be exerted on the stem.

In some implementations, the proximal portion 40 of the stem 38 can be cylindrical. The distal portion 42 can be generally half-cylindrical or partial-cylindrical, as illustrated in FIG. 7, although various other shapes and configurations may be used. The distal portion 42 may have a cross-section that is a sector of the cross-section of the proximal portion 40. The distal portion 42 may have a cross-section that is a segment of the cross-section of the proximal portion 40. Such a segmental distal portion can have a cross-section defined by a cord that is spaced away from the center of the circular cross-section of the proximal portion 40, e.g., by about 10%-15% of the diameter of the circular cross-section of the proximal portion 40. The distal and proximal portions are preferably configured to be generally parallel and have a single longitudinal axis. The proximal and distal portions of the stem preferably have a one-piece integral structure.

Referring to FIGS. 12 and 13, in some implementations, the distal portion 42 may have an outer surface 162 that is co-planar and continuous with the adjacent outer surface of the proximal portion 40. The distal portion 42 can also have an inner surface 164 that can be generally flat and extends to meet the proximal portion at a generally normal angle. The distal and proximal portions can be configured and connected such that there is a connection surface 166 (which can be defined by the part of the end of the proximal portion to which the distal portion does not attach) for mounting the finger. The connection surface 166 can be substantially normal to the longitudinal axis of the stem and/or to the inner surface 162. The finger can be mounted using a bolt or other fastener that is secured within a fastening hole 168 that extends into the proximal portion 40 from the connection surface 166. The fastener preferably extends axially into the proximal portion.

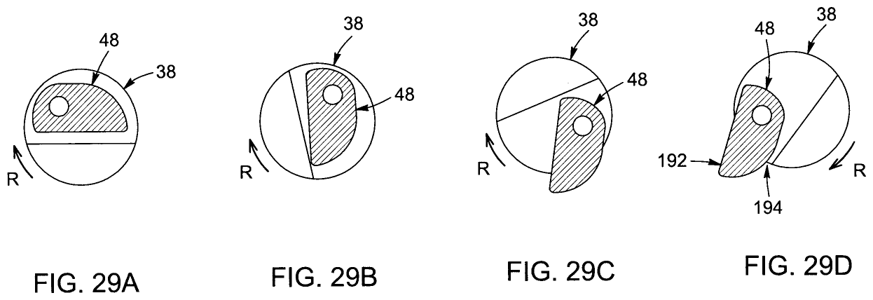

Referring still to FIGS. 12 and 13, the fastening hole 168 can positioned depending on the size and shape of the finger and can be offset from the cross-sectional center of the stem (e.g., of the proximal portion). FIGS. 29A to 29D illustrate the finger pivotally mounted with a fastener having an offset position.

It is noted that certain components can be sized to provide an amount of play therebetween. For example, the fastener that pivotally retains the finger can be slightly smaller than the hole in the finger through which is passes, providing an amount of play. In addition, the finger can be sized and configured so that there is an amount of play in between its rear end and the inner surface of the distal portion to facilitate pivoting from closed to open positions, as illustrated in FIGS. 29A to 29D.

Turning now to FIG. 14, in some implementations the finger 48 can have an opening 170 through which a fastener can pass to pivotally secure the finger 48 to the stem. The finger 48 can also have a rear end 172 and a forward end 174, the rear end having the opening 170 and the forward end being the distal part that engages the winch drum. In some implementations, the finger 48 can have a size, shape and configuration to be located within the nook of the distal and proximal portions of the stem, as illustrated in FIG. 7, and to not extend beyond the cylindrical boundary that would be defined by the proximal portion of the stem. The finger 48 can have a rounded polygon cross-sectional shape. The rear end can have a generally rectangular cross-sectional shape (e.g., with rounded corners) and the forward end can have a generally triangular or quarter-circle cross-sectional shape. In some scenarios, the finger can have a quarter-stadium cross-sectional shape. The finger 49 can have a bottom surface 176 that is generally flat and straight, and a tom surface that has a contoured portion 178 and a flat part 180. The top surface of the finger 48 can be provided to generally follow the contour or curvature of the outer surface of the proximal portion, as illustrated in FIG. 7. The thickness of the FIG. 48 can be constant along its length. The part of the finger 48 that passes through an opening in the winch drum is sized to be smaller than the opening. The finger 48 is preferable a one-piece integral structure.

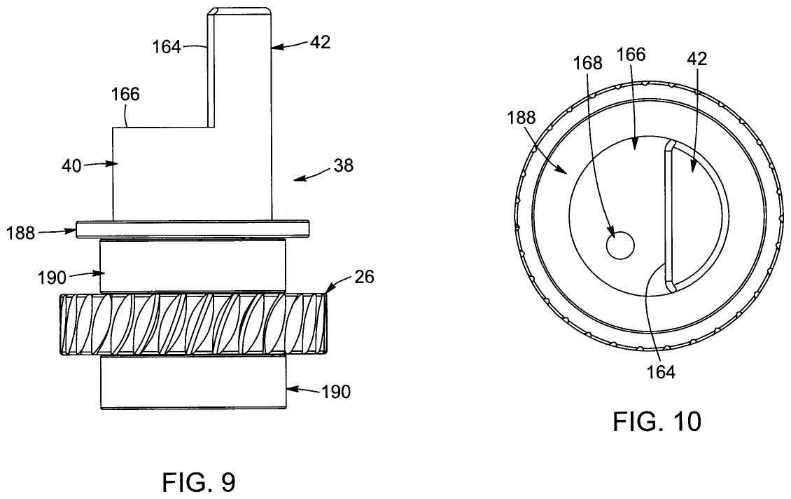

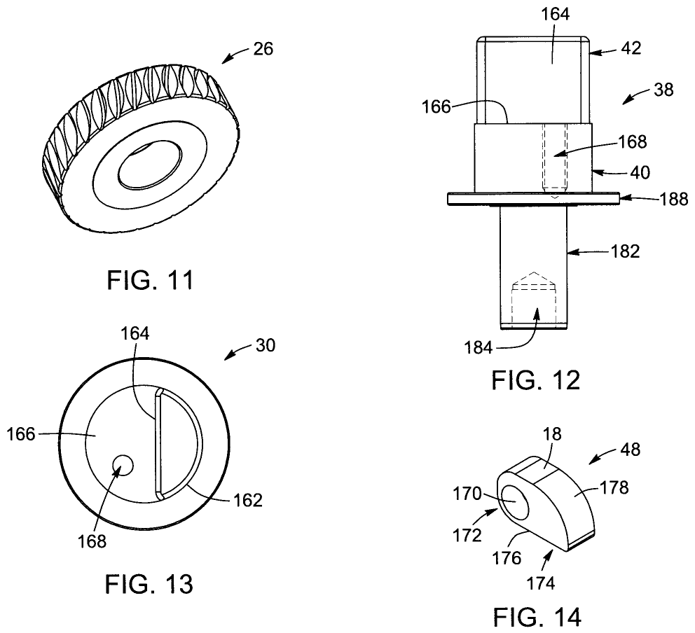

Referring to FIG. 13, the stem 38 can also include a rear portion 182 that can be inserted within the gear 26 (as shown in FIG. 11). The rear portion 182 can include a back hole 182 into which a cap 186 (as shown in FIG. 16) can be fit. FIG. 13 also illustrates a stem flange 188 that is connected to the proximal portion 40 and abuts on the gear box (ass shown in FIG. 7). FIG. 9 also shows an annular insert 190 can be provided in between the rear portion 182 of the stem 38 and the gear 26.

Referring to FIGS. 7 and 22 to 27, the gear box can include two compartments 120A and 120B, which can be coupled using various mechanisms, such as screws or bolts or other types of fasteners.

Referring now to FIGS. 29A to 29D, the stem 38 and finger 48 are schematically illustrated during rotation of the stem 38 in direction R. When the finger is pivotally mounted to the stem it is able to move from a retracted position (as in FIGS. 29A and 29B) to an extended position (as in FIGS. 29C and 29D). The finger 48 can pivot to the extended position by gravity once rotation is sufficient. Once in the extended position, the finger can engage the winch drum via one of the lateral openings. Referring to FIG. 29D, the finger 48 can engage the winch drum at an engagement region 192 while the opposing side of the finger abuts on the stem (e.g., on part of the distal portion which may be the inner surface or an edge between the inner and outer surfaces) at an abutment region 194. The engagement region 192 and/or the abutment region 194 can be provided with various features, such as reinforcements, surface treatments, structural features such as grooves or cooperating shapes with respect to the elements that they contact, and so on.

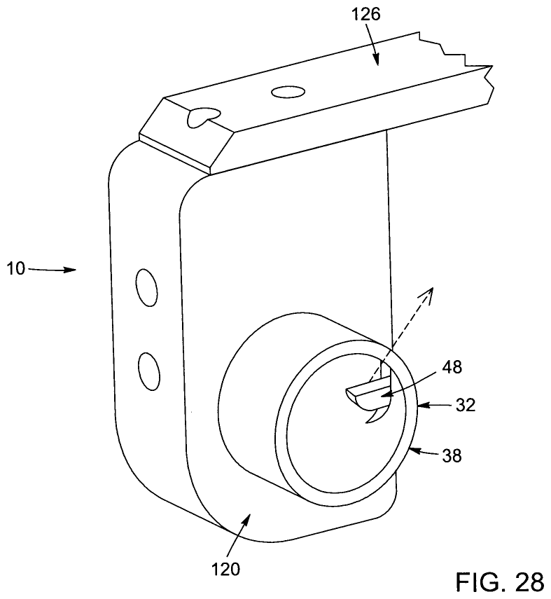

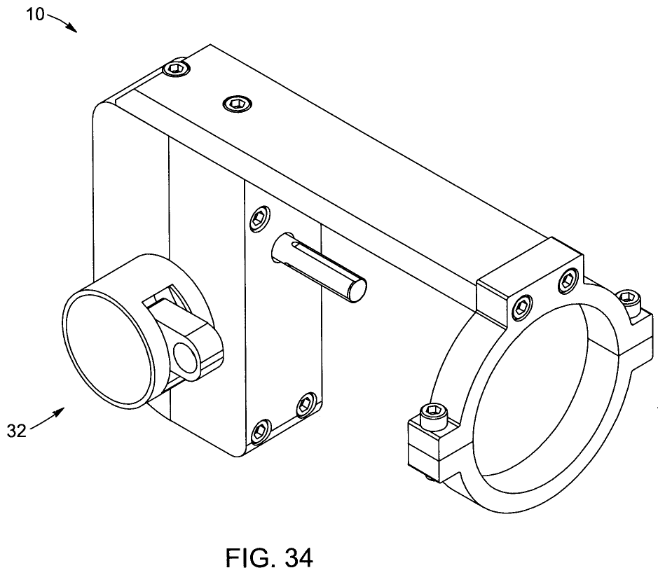

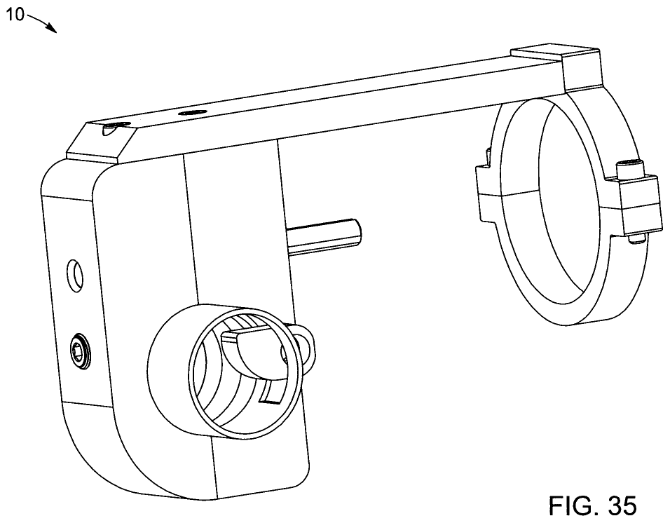

Referring now to FIG. 28, another embodiment of a winch-winding assembly and some of its components are illustrated. In this embodiment, the engagement arm 32 has an alternative construction where the stem 38 has a tubular structure and the finger 48 is mounted such that it extends inwardly to engage the opening in the winch drum from the outside, rather than from the inside as with the other embodiments described herein. In this embodiment, the finger 48 can be mounted to pivot or pass within a slot provided in the stem. The finger 48 can be mounted within the tubular wall or outside the tubular wall using various mechanisms and arrangements. For example, the tubular wall may be thick enough to provide a bolt that passes through a hole in the finger 48, similar to what is described and illustrated for the embodiment of FIG. 7 but with the bolt passing into the tubular wall of the stem. The stem may be provided with an external mounting structure on the outside of the tubular member and to which the finger 48 is pivotally mounted. Thus, for this embodiment, the tubular stem is provided over the which drum, i.e., the end of the winch drum is inserted into the tubular stem, and the stem is rotated to a position at which the finger falls into the opening of the winch drum and engages it to enable rotation of the winch drum and rolling of the strap. In the embodiment of FIG. 28, the other components (e.g., gears, drill support mechanisms, etc.) of the assembly 10 can be substantially similar to those of the other embodiments described in detail herein. FIGS. 34 and 35 also illustrate an embodiment of a winding assembly 10 where the engagement arm includes a finger extends from the outside of a hollow stem into the cavity in order to engage a drum for rotation.

It is also noted that embodiments of the winch-winding assembly described and illustrated herein can also be used with or adapted for winding applications other than winding tie-down straps using a flatbed winch. In some scenarios, the winch-winding assembly can be used for winding a winch or other type of rolling device for winding an elongated flexible structure, such as a tube, a hose, a cord, an electrical wire or line, an extension cord, a strap or other type of flat flexible elongated element, and the like. In some scenarios, the winding assembly 10 is used for elongate flexible elements that still have some rigidity, such as cold or ice-coated straps, in order to reform the elongate elements around the winding drum. In other implementations, the assembly 10 can be used with a drill or another type of drive device for engaging with and rotating various different rotatable shafts in different applications. In some scenarios, embodiments of the winding assembly can be used in conjunction with a manual crank or another manual drive device rather than a drill or motorized drive device. The drill-support mechanism could be adapted to support and/or guide other types of motorized or manual drive devices.

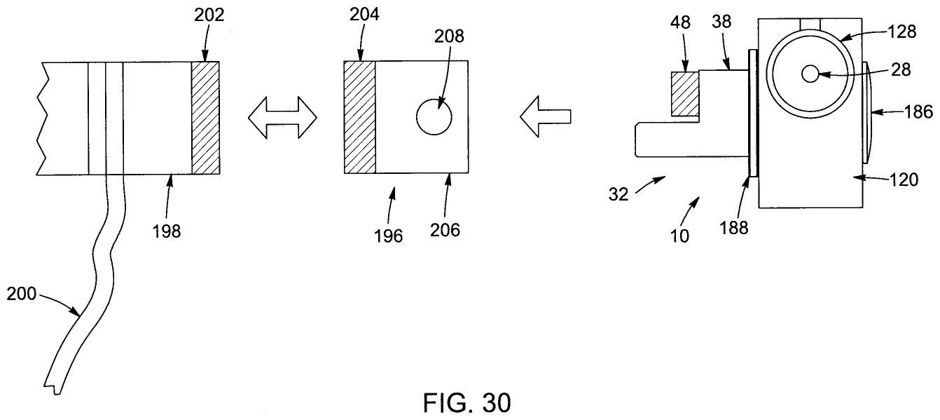

Referring to FIG. 30, in some scenarios an adaptor 196 can be provided for facilitating coupling of the winch-winding assembly 10 with a rotatable winding device 198 for winding an elongate flexible element 200. The rotatable winding device 198 can include a connection element 202 which may be at an end of the rotatable drum around with the elongate flexible element 200 can be wound. The adaptor 196 includes an adaption portion 204 and an engagement portion 206, the former being configured for coupling to the connection element 202 to secure together, and the latter being configured for engagement by the engagement arm 32 of the winding assembly 10. The adaption portion 204 can include various constructions, e.g., a universal adaptor that can be secured to various cylindrical drums or structures, or by various mechanisms such as pins, clamps, chemical bonding, fasteners, and so on. The engagement portion 206 can include an opening 208 and can have a similar shape and construction as the end of a winch drum used in flatbed tie-down strap applications. The engagement portion 206 is configured to allow insertion of the engagement arm 32 of the winding assembly 10 so that the finger 48 can engage the adapter and enable rotation thereof, thus allowing the elongate flexible element 200 to be rolled or wound around the rotatable winding device 198.

The winding assembly 10 can be manufactured and sold alone for a pre-determined purpose, such as flatbed tie-down straps, or a variety of end uses. In some scenarios, the winding assembly 10 can be provided as part of a pre-assembled drill-and-assembly unit (as illustrated in FIG. 2, for example) where the collar has been securely fastened to the neck of the drill or another appropriate part of the drill. Various kinds of drills can be used, preferably those having a portion on the neck to which the collar can be securely fastened. In the pre-assembled drill-and-assembly unit, the drill can also be pre-coupled to the drive shaft 28, making the unit ready for use. In some scenarios, the winding assembly 10 can be provided as part of a kit, which may include a drill, an adaptor (e.g., 196 in FIG. 30), and other components, such as a tool for securing the components together (e.g., tool for securing collar to the drill), drill batteries, lighting attachments, and so on. In some scenarios, a set of different fingers having different shapes and/or sizes can be provided as part of the kit for different applications (e.g., depending on the size and configuration of the winch drum to be engaged and rotated). The kit may include instructions regarding assembly and use of the assembly. For example, the instructions may indicate a certain drill setting that may be preferred for operation of the winding assembly (e.g., screw setting preferred; torque level; speed of rotation; direction of rotation for engagement and winding versus disengagement and removal of the assembly; setting for automatic shutoff or break of the drill; etc.).

In some implementations, the winding assembly 10 can include two engagement arms 32 extending from opposed sides (e.g., of the gear box) to enable cooperation with a winch device or the like from either direction. This can be useful particularly for scenarios where drums of different types, constructions or accessibilities are to be rotated. In addition, the engagement arm can be configured to be removably connectable to the gear box such that a single arm component can be used on either side of the gear box.

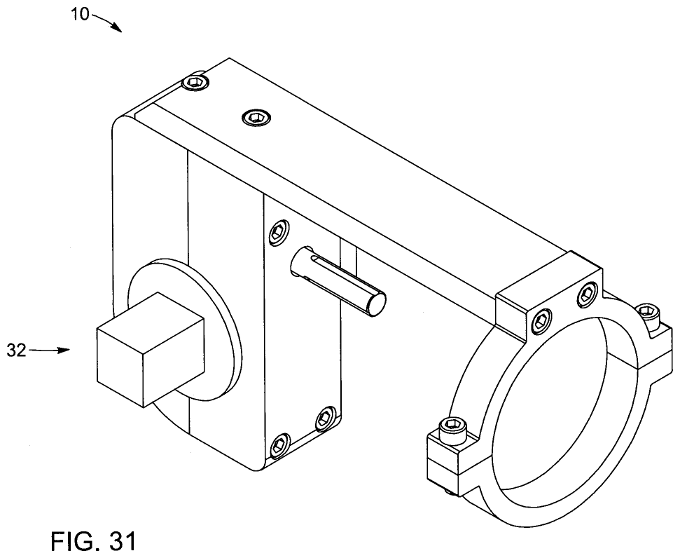

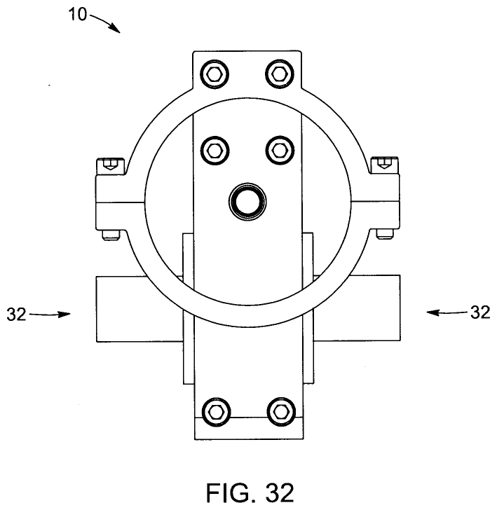

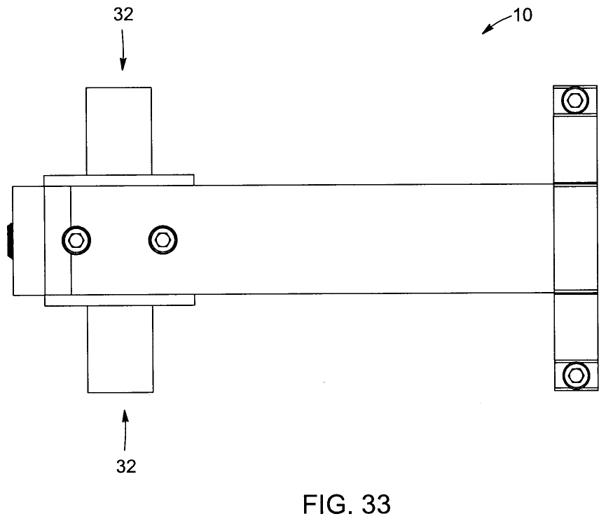

In some implementations, referring to FIGS. 31 to 33, the winding assembly 10 can be configured such that the engagement arm includes a block for insertion into a corresponding windable drum. The block can be configured and shaped to have at least one side engagement surface that abuts against an internal surface of the windable drum to rotate the drum. The block may be configured to have a corresponding shape to the drum. The block may be composed of solid metallic material, and may have a cross-section that is constant along its length and that is substantially square or rectangular. As illustrated in FIGS. 32 and 33, there may be two opposed blocks extending from either side of the gear box of the winding assembly. In some scenarios, all of the other features of the assembly, such as the gear box, the support arm and collar can be the same as described above for other embodiments.

In some implementations, the winding assembly 10 having a block engagement arm can be used for train or railway applications where rotatable drums/shafts having square-shaped cavities are used. The block can be inserted within the square cavity of the shaft, and then rotated in order to exert rotational force on the shaft to enable rotation. Square cavity shafts used in the railway industry can be accessible from only one direction, and thus the winding assembly 10 can have two blocks extending from either side of the gear box in order to facilitate insertion and rotation from either side. FIGS. 31 to 33 provide example illustrations of the assembly 10 and blocks that can be used for railway applications. In some scenarios, the engagement arm can have a configuration to engage other types of rotatable elements, and may for example include an end cavity defined by side walls that receives the end of a rotatable element and the side walls have internal surfaces that abut against the end of the rotatable element to facilitate rotation.

In some implementations, the engagement arm can be removably connectable to the gear system via a connection mechanism, which may include a quick-clip mechanism, lip-and-groove, nodule-and-groove, magnetic, and/oor other types of connections. It should be noted that engagement arms of different types, sizes and/or configurations can be provided for different applications. For example, a set of engagement arms can be provided and can be removably connectable to the gear system. At least one of the engagement arms can be a stem-and-finger type as described as illustrated herein. In some scenarios, engagement arms can be provided to be removably connectable to both sides of the gear system; for instance, one engagement arm can be configured to be connectable to a first side of the gear system and another engagement arm can be configured to be connectable to a second side of the gear system, with the two engagement arms being configured to have the appropriate orientation for engaging and rotating a winch drum or other type of rotatable element from the respective sides. The set of engagement arms can includes arm adapters designed for specific applications, such flatbed winch drum winding, rotation of drum or other rotatable elements used in railway applications, and other rotation applications, particularly applications that require a 90 degree angle between the drill drive direction and the rotation axis. The connection mechanism for mounting the arms to the gear system can include a connector portion protruding out from the gear system and having a structure enabling the arms to fit over or within the connector portion to become rotationally fixed relative to the connector portion. Thus, when the connector portion is rotated by the gear system, the arm can be rotated accordingly. In some scenarios, the connector portion can be similar or identical to the block as illustrated herein, and the arms can include a proximal portion that connects relative to the block.

In some scenarios, the winding assembly 10 maybe used with a Makita™ drill, preferably used in screw-mode at a level of 7 or 8. The collar can be configured to attach to the neck of the drill where a drill-grip could be connected.

In the above description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present invention illustrated in other figures can be easily inferred therefrom. The embodiments, geometrical configurations, materials mentioned and/or dimensions shown in the figures are optional, and are given for exemplification purposes only.

Furthermore, although the present invention may be used with various objects, such as flatbed winches, for example, it is understood that it may be used with other winding objects. For this reason, expressions such as “flatbed winch”, “winch”, etc. as used herein should not be taken as to limit the scope of the present invention to these devices, on which a rope or strap is to be wound, in particular. These expressions encompass all other kinds of materials, objects and/or purposes with which the present invention could be used and may be useful, as can be easily understood.

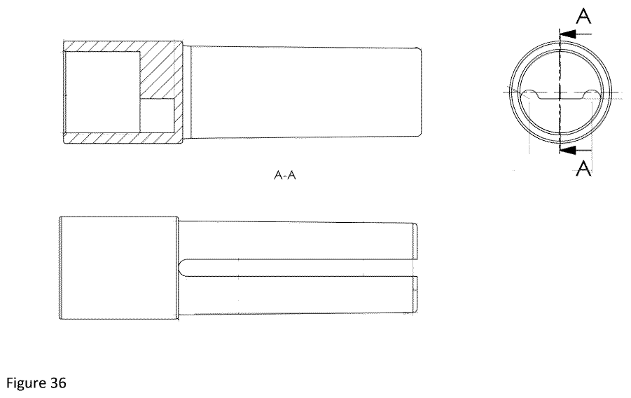

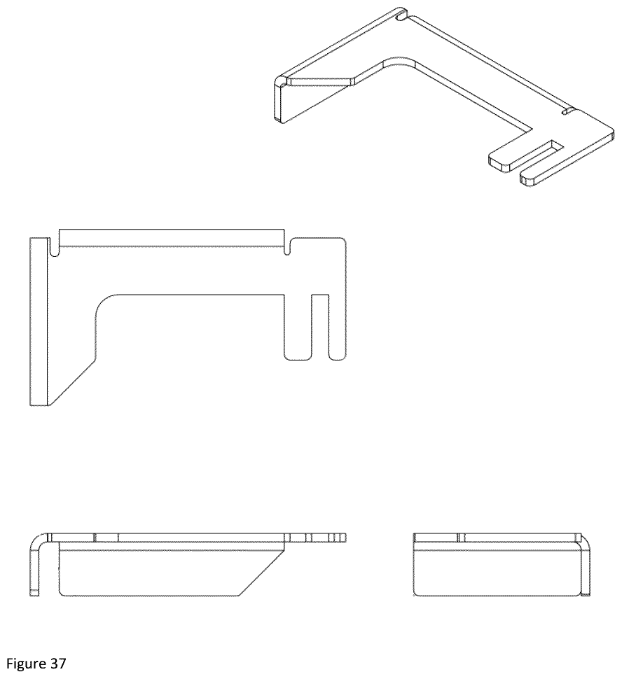

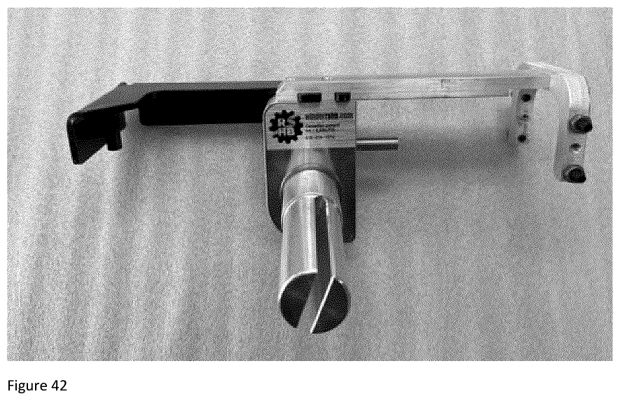

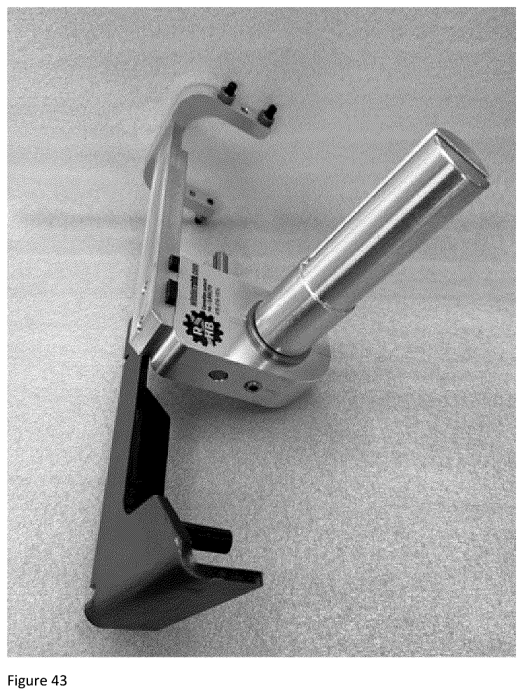

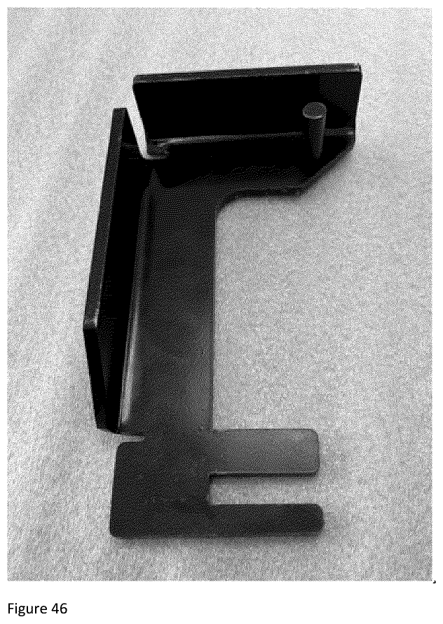

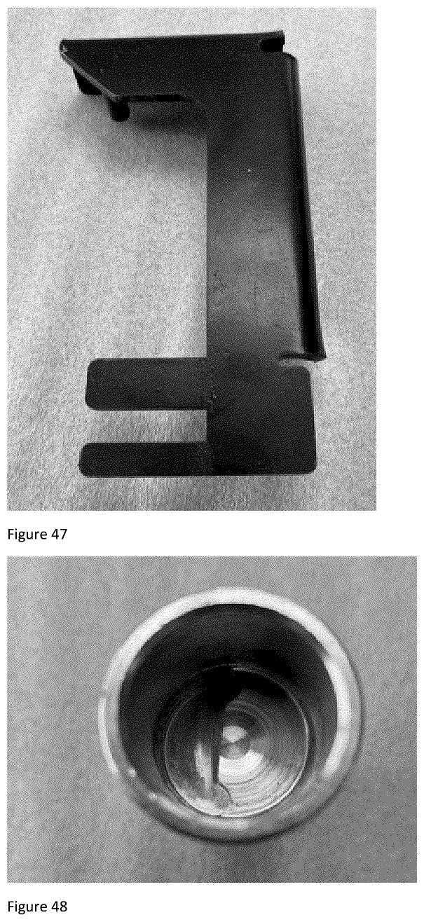

Now turning to FIGS. 36 to 48, the system can include the winding assembly, the bracket and the needle. The bracket can be configured in various ways so as to fit over part of the flatbed to support the rest of the system including the drill. As shown in FIG. 42, the far left end can fit over the flatbed and there is a peg that can fit into a corresponding hole such that the drill will be facing perpendicular to the edge of the flatbed and the needle will be pointing parallel to the edge of the flatbed.

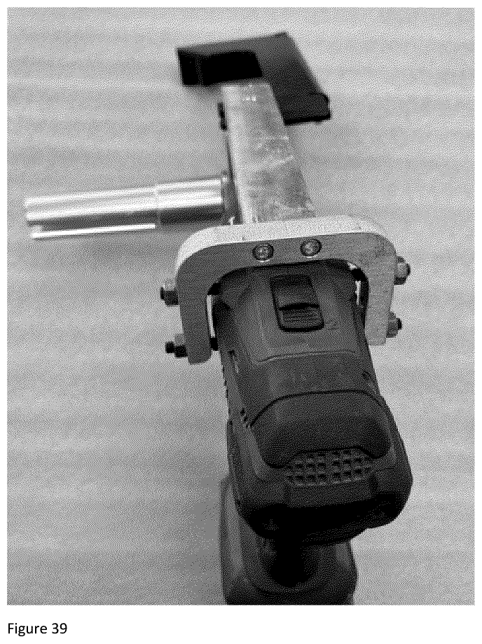

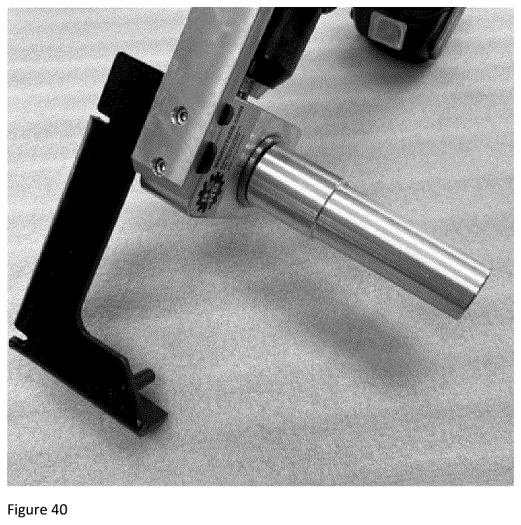

As shown in FIG. 37, the bracket can include a main plate section, two side wall sections that extend down from two edges of the main plate section and which are separated by a gap, and a connector which can be configured as at least one finger plate (e.g., two finger plates) that can extend into corresponding openings in the assembly as shown in FIGS. 39 and 40 for example. The opening(s) in the assembly can be provided (e.g., machined) in the support arm of the drill-support system. It is noted that the bracket can have various shapes, sizes and configurations depending on the structure to which it is mounted and depending on the connection structure for connecting to the assembly. For example, the assembly could have projections that extend into openings in the bracket, or vice versa.

Referring to FIG. 36, the needle includes a coupling mechanism for coupling to the rotating element of the assembly. This coupling mechanism can include a cavity that has a shape corresponding to that of the rotating element, for example. For example, as shown in FIG. 39, the needle can be slotted over the rotating element such that the engagement arm fits within the cavity, such that when the engagement arm is rotated the needle rotates accordingly. The needle also has a strap connection part to which the end of the strap is connected at the beginning of the winding. The strap connection part can include a slot through which the end of the strap can fit. The slot can be defined as an elongated opening defined in between two prongs that have opposed inner surfaces that face each other. As shown in the Figures, the prongs can have outer surfaces that are cylindrical (e.g., each being a half cylinder) while the inner surfaces are generally flat. The prongs can have a length to define the slot to have a length that is generally the same or greater than the width of a strap. The slot can facilitate initial mounting of the strap to the needle so that the initiation of the winding can be facilitated. Other strap connection structures could also be used. Alternatively, the strap connection structure could simply be the outer cylindrical surface of the distal part of the needle, though in this case the user may have to manually wind the strap the first few times to facilitate a tight connection to initiate the drill-driven winding. It is noted that the strap can be coupled to the needle before or after the needle is mounted to the rotating element of the assembly.

It is also noted the needle can have a step-up structure where the distal portion has a smaller diameter than the proximal portion to define a guide point for strap winding. The user can align the strap to wind only around the distal portion (e.g., defined by the prongs) and the step-up can be a visual aid and can guide the strap at least during initial winding.

Once the strap has been wound off of the winch barrel and onto the needle, the rolled-up strap can be removed from the needle and placed in a storage container that may be on the flatbed or cabin of the truck. The system can then be used to wind up the next strap, and so on, until all of the straps have been wound up and stored when not in use. When the straps are again required, they can be removed from storage and one-by-one wound back onto the winch drum. For reinstallation of the straps, the needle is not required; rather, the rotating element is inserted into the winch drum, the strap end is mounted to the drum, and then rotation of the drum enables winding of the strap back onto the drum. The straps can then be used for tying down a load located on the flatbed, as described herein.

It is also noted that the bracket can be used without the needle when a user does not wish to support the weight of the drill and assembly when winding the winch drum or other winding applications. The needle facilitates winding the straps off of the winch drums for removal and storage. It is thus possible to use the system where the assembly is used only with the needle (no bracket) or only with the bracket (no needle) depending on the application.

It is also mentioned that the needle can be viewed as a kind of adaptor, as described herein, which has the use of facilitating winding the strap off of the drum or off of another structure, depending on the application. Embodiments of the needle can thus be seen as an embodiment of an adaptor. It is also noted that the needle can be used not only with the winding assemblies described herein, but also with other types of drill-driven or manual winding devices that can have various configurations, angles, shapes and other features. One advantage of certain embodiments of the system is that the assembly can be configured for engaging a drum for winding while the needle is configured to be removably mounted to the assembly for the application of removing the strap from the drum and providing it as a wound-up roll for storage or otherwise.

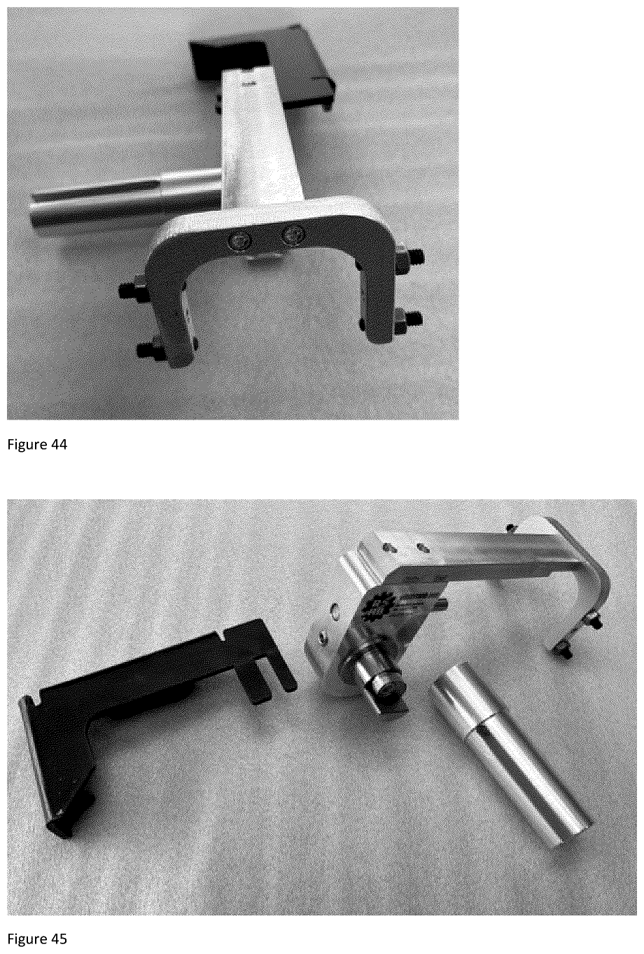

The bracket, needle and assembly can be provided as a kit in a decoupled configuration within a container such that a user can couple the components together during operation and then decouple the components for storage in the container when the operation is complete. FIG. 45 shows the kit in a decoupled configuration and FIG. 44 shows the kit when the components are coupled together.

Furthermore, each of the assembly, the bracket and the needle can be viewed as distinct devices. Thus, embodiments of the invention description herein can include the bracket, the needle or the assembly as described herein.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

What is claimed is:

1. A system for use with flatbeds for winding and storing a strap, comprising:
a strap winding assembly having a rotating element to drive winding of the strap;
a bracket configured for connecting to the strap winding assembly and the flatbed to support the strap winding assembly with respect to the flatbed; and
a needle removably mounted to the rotating element and being configured to receive to the strap, such that rotation of the rotating element causes rotation of the needle so that:
for storing the strap, the strap is unwound from a drum on the flatbed and would up onto the needle, the wound-up strap being removable from the needle for storage; and
for using the strap on the flatbed, an end of the wound-up strap is mounted to the drum such that rotation of the drum enables winding of the strap back onto the drum.

2. The system of claim 1, wherein the needle comprises a proximal portion configured to receive and engage part of the rotating element, and a distal portion extending from the proximal portion and configured to engage with the strap.

3. The system of claim 1, wherein the bracket comprises a peg that is configured to fit into a corresponding hole in the flatbed such that a drill mountable to the strap winding assembly faces perpendicular to an edge of the flatbed and the needle points parallel to the edge of the flatbed.

4. The system of claim 1, wherein the bracket includes a main plate section, two side wall sections that extend down from two edges of the main plate section and which are separated by a gap, and a connector which is configured as at least one finger plate that extend into corresponding openings in the strap winding assembly.

5. The system of claim 1, wherein the needle includes a coupling mechanism for coupling to the rotating element of the strap winding assembly.

6. The system of claim 5, wherein the coupling mechanism includes a cavity that has a shape corresponding to that of the rotating element.

7. The system of claim 1, wherein the needle is slotted over the rotating element such that an engagement arm of the rotating element fits within the cavity, such that when the engagement arm is rotated the needle rotates accordingly.

8. The system of claim 1, wherein the needle has a strap connection part to which the end of the strap is connected at the beginning of the winding.

9. The system of claim 8, wherein the strap connection part includes a slot through which the end of the strap can fit.

10. The system of claim 8, wherein the slot is defined as an elongated opening defined in between two prongs that have opposed inner surfaces that face each other.

11. The system of claim 10, wherein the prongs have outer surfaces that are cylindrical, each being a half cylinder, while the inner surfaces are generally flat.

12. The system of claim 10, wherein the prongs have a length to define the slot to have a length that is generally the same or greater than the width of a strap.

13. A system for winding and storing a strap, comprising:
a strap winding assembly having a rotating element to drive winding of the strap;
a bracket configured for connecting to the strap winding assembly and a structure to support the strap winding assembly with respect to the structure; and
a needle removably mounted to the rotating element and being configured to receive to the strap, such that rotation of the rotating element causes rotation of the needle so that:
for storing the strap, the strap is unwound from a drum on the structure and would up onto the needle, the wound-up strap being removable from the needle for storage; and
for using the strap on the structure, an end of the wound-up strap is mounted to the drum such that rotation of the drum enables winding of the strap back onto the drum.

14. The system of claim 13, wherein the needle comprises a proximal portion configured to receive and engage part of the rotating element, and a distal portion extending from the proximal portion and configured to engage with the strap.

15. The system of claim 13, wherein the bracket is configured to fit on the structure such that a drill mountable to the strap winding assembly faces perpendicular to an edge of the structure and the needle points parallel to the edge of the structure.

16. The system of claim 13, wherein the bracket includes a main plate section, side wall sections that extend down from edges of the main plate section and which are separated by a gap, and a connector which is configured as at least one finger plate that extend into corresponding openings in the strap winding assembly.

17. The system of claim 13, wherein the needle includes a coupling mechanism for coupling to the rotating element of the strap winding assembly.

18. The system of claim 17, wherein the coupling mechanism includes a cavity that has a shape corresponding to that of the rotating element.

19. The system of claim 13, wherein the needle is slotted over the rotating element such that an engagement arm of the rotating element fits within the cavity, such that when the engagement arm is rotated the needle rotates accordingly.

20. The system of claim 13, wherein the needle has a strap connection part to which the end of the strap is connected at the beginning of the winding, wherein the strap connection part includes a slot through which the end of the strap can fit, wherein the slot is defined as an elongated opening defined in between two prongs that have opposed inner surfaces that face each other, wherein the prongs have outer surfaces that are cylindrical, each being a half cylinder, while the inner surfaces are generally flat, and wherein the prongs have a length to define the slot to have a length that is generally the same or greater than the width of a strap.
